(19) United States
(12) Patent Application Publication
(10) Pub. No.: US 2007/0271406 A1
(43) Pub. Date: Nov. 22, 2007

(54) Image Processing Device

(75) Inventors: Yo Sawamura, Kyoto (JP); Tetsuya Takemura, Kyoto (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: ROHM CO., LTD., Ukyo-ku, Kyoto (JP)

(21) Appl. No.: 10/599,970

(22) PCT Filed: Apr. 15, 2005
(86) PCT No.: PCT/JP05/07339

§ 371 Date: Jun. 19, 2007

(30) Foreign Application Priority Data
Apr. 16, 2004 (JP) 2004-122251
Apr. 14, 2005 (JP) 2005-117354

(51) Int. Cl. G06F 13/36

(52) U.S. Cl. 710/310

(57) ABSTRACT

An image processing device includes a high-speed bus and a peripheral bus linked via a bus bridge, and connected to the buses are a CPU for carrying out computations and control of image processing, a data transceiving FIFO memory for carrying out transceiving of image compression data with a host device, a frame memory for storing image expansion data from an electronic camera and the like and displaying the data on a display panel, and a compression/expansion circuit for carrying out compression of image expansion data and expansion of image compression data. The CPU and the frame memory are connected to the high-speed bus and the data transceiving FIFO memory is connected to the peripheral bus. The arrangement of the image processing device makes the CPU operate more efficiently to achieve overall increased speed in image processing.

### BACKGROUND OF THE INVENTION

1. Field of the Invention

The present invention relates to an image processing device in which compression/expansion of image data can be carried out.

2. Description of the Related Art

In recent years, in addition to displaying image data, electronic apparatuses such as mobile telephones also display and store image data that has been captured by electronic camera capabilities equipped therein. Consequently, such electronic apparatuses require complex processing to be performed on large amounts of image data and, in general, use image processing devices in which a CPU is used (for example, see Japanese Patent Application Laid-open No. 2001-350461 and Japanese Patent Application Laid-open No. 2002-77709).

FIG. 3 shows one example of a conventional image processing device. An image processing device 101 has a bus architecture in which a high-speed bus 10 and a peripheral bus 12 are linked via a bus bridge 11, and various functional circuits are connected to both of the buses 10 and 12. The high-speed bus 10 is connected to a CPU 13 for carrying out computations and control necessary for image processing and the like, a ROM 14 that stores a processing program of the CPU 13, and a RAM 15 used as a working area and the like for the computations carried out by the CPU 13. The peripheral bus 12 is connected to a frame memory 16 that stores image expansion data from an electronic camera 2 or image expansion data to which image compression data from a host device 4 is expanded and displays this data on a display panel 3 such as an LCD, a compression/expansion circuit 17 for carrying out compression of image expansion data and expansion of image compression data, a transceiving FIFO (first in first out) memory 18 for carrying out transceiving of image compression data to and from the host device 4, and a general-purpose timer circuit 19 and the like. The image processing device 101 includes a frame memory register 20 in which data of the frame memory 16 is read and written by the CPU 13, a compression/expansion circuit register 21 in which data of the compression/expansion circuit 17 is read and written by the CPU 13, and a data transceiving register 22 in which data of the data transceiving FIFO memory 18 is read and written by the CPU 13. It should be noted that in the present application, image compression data refers to image data that is compressed and image expansion data refers to image data that has not been compressed.

Image expansion data from the electronic camera 2 is stored in the frame memory 16 and displayed on the display panel 3 and is also read in by the CPU 13 via the frame memory register 20 and the peripheral bus 12 and compressed using the compression/expansion circuit 17 and the RAM 15 and the like. The resulting image compression data is written into the data transceiving FIFO memory 18 via the peripheral bus 12 and the data transceiving register 22 and sent in order to the host device 4. On the other hand, image compression data from the host device 4 is received at the data transceiving FIFO memory 18 and read in order into to the CPU 13 via the data transceiving register 22 and the peripheral bus 12, then expanded using the compression/expansion circuit 17 and the RAM 15 and the like. The resulting image expansion data is stored in the frame memory 16 via the peripheral bus 12 and the frame memory register 20 and displayed on the display panel 3.

Image processing is performed in this manner, but to achieve higher picture quality of the displayed images and a variety of moving and still pictures, even greater speed is required in image processing. To achieve greater speed in image processing it is common to increase the speed of all of the functional circuits including the CPU, but when giving consideration to such factors as power consumption and cost, it is also essential in addition to the above factors to make the CPU operate efficiently.

### SUMMARY OF THE INVENTION

In order to overcome the problems described above, preferred embodiments of the present invention provide an image processing device capable of enabling a CPU to operate more efficiently and thus achieve greater speed in image processing.

In order to solve the aforementioned problems, an image processing device according to a preferred embodiment of the present invention is an image processing device in which a high-speed bus and a peripheral bus are linked via a bus bridge. Connected to the high-speed bus and the peripheral bus are a CPU for carrying out computations and control of image processing, a data transceiving FIFO memory for carrying out transceiving of image compression data with a host device, a frame memory for storing image expansion data and displaying this data on a display panel, and a compression/expansion circuit for carrying out compression of image expansion data and expansion of image compression data, wherein the CPU and the frame memory are connected to the high-speed bus, and the data transceiving FIFO memory is connected to the peripheral bus.

In this image processing device, it is preferable that the compression/expansion circuit is connected to the high-speed bus.

An image processing device according to another preferred embodiment of the present invention is an image processing device including a CPU-direct instruction bus, a CPU-direct data bus, and a high-speed bus. Connected to these buses are a CPU for carrying out computations and control of image processing, a ROM for storing a processing program of the CPU, a RAM used as a working area for the computations carried out by the CPU, a data transceiving FIFO memory for carrying out transceiving of image compression data with a host device, a frame memory for storing image expansion data and displaying this data on a display panel, and a compression/expansion circuit for carrying out compression of image expansion data and expansion of image compression data, wherein the CPU and the ROM are connected to the CPU-direct instruction bus; the CPU, the RAM, and the frame memory are connected to the CPU-direct data bus; and the CPU and the data transceiving FIFO memory are connected to the high-speed bus.

In this image processing device, it is preferable that the compression/expansion circuit is connected to the CPU-direct data bus.

According to the preferred embodiments of the present invention, in the image processing device, the frame memory, which stores a large volume of data, is connected to a bus having a relatively high processing capability, and the data transceiving FIFO memory, which stores a comparatively small volume of data, is connected to a bus having a relatively low processing capability, and therefore, the CPU can be made to operate efficiently and thus achieve greater speed in overall image processing.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram of an image processing device according to a preferred embodiment of the present invention.

FIG. 2 is a block diagram of an image processing device according to another preferred embodiment of the present invention.

FIG. 3 is a block diagram of a conventional image processing device.

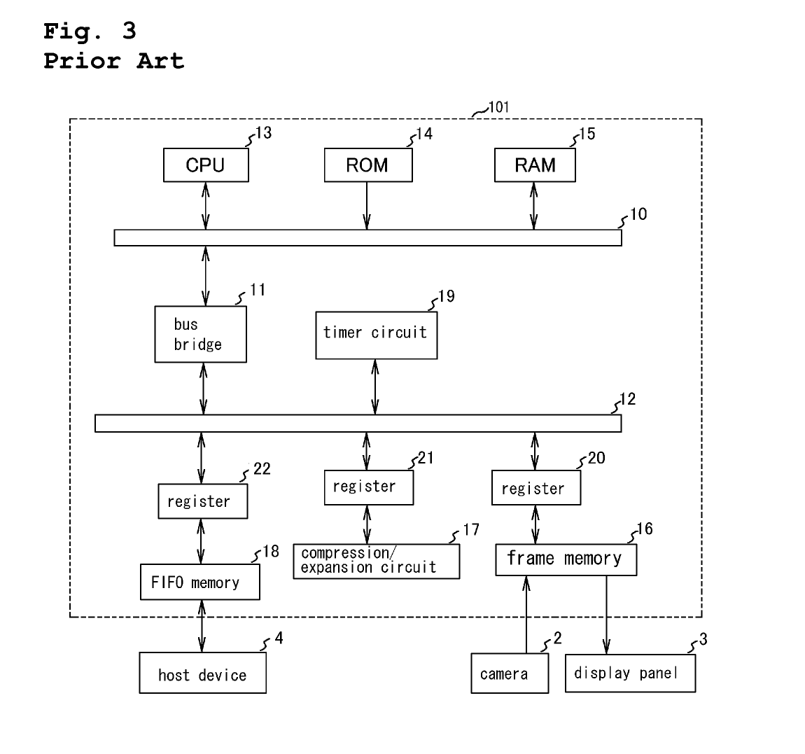

### DETAILED DESCRIPTION OF PREFERRED EMBODIMENTS

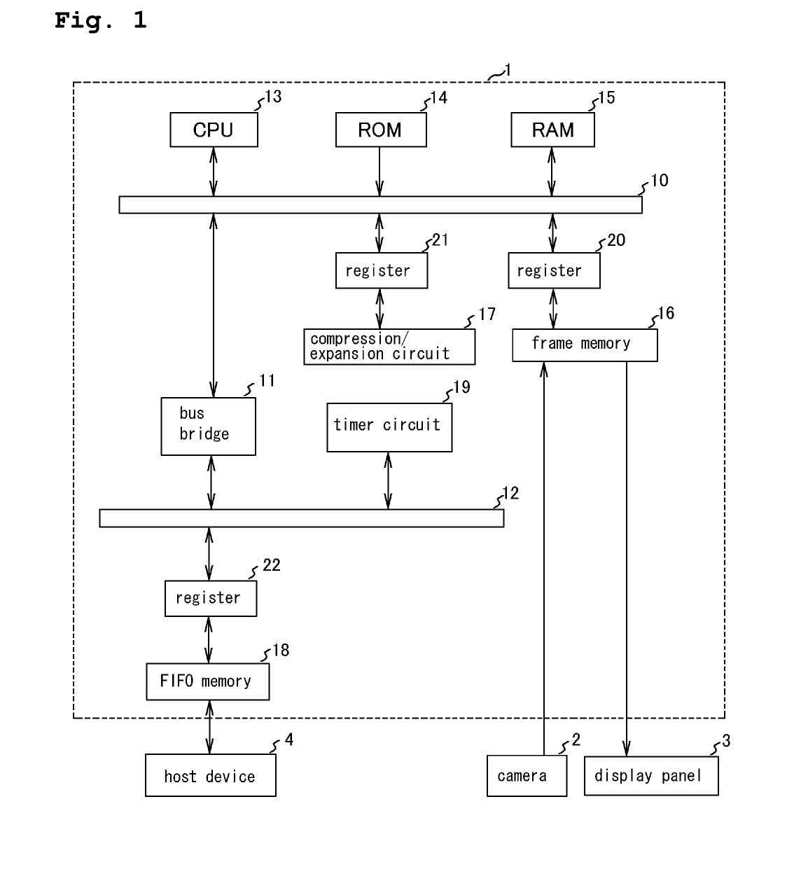

Hereinafter, preferred embodiments of the present invention are described with reference to the drawings. FIG. 1 is a block diagram of an image processing device according to a preferred embodiment of the present invention. An image processing device 1 has a bus architecture in which a high-speed bus 10, which operates at a high frequency of 75 MHz for example, and a peripheral bus 12, which operates at a frequency of 25 MHz for example, are linked via a bus bridge 11, and various functional circuits are connected to both of the buses 10 and 12. The high-speed bus 10 is connected to a CPU 13 for carrying out computations and control necessary for image processing and the like, a ROM 14 that stores a processing program of the CPU 13, and a RAM 15 used as a working area and the like for the computations carried out by the CPU 13. Furthermore, the high-speed bus 10 is connected to a frame memory 16 that stores image expansion data from the electronic camera 2 or image expansion data to which image compression data from the host device 4 is expanded and displays this data on the display panel 3 such as an LCD, and a compression/expansion circuit 17 for carrying out compression of image expansion data and expansion of image compression data. The peripheral bus 12 is connected to a transceiving FIFO memory 18 for carrying out transceiving of image compression data to and from the host device 4, and a general-purpose timer circuit 19 and the like. The image processing device 1 includes a frame memory register 20 in which data of the frame memory 16 is read and written by the CPU 13, a compression/expansion circuit register 21 in which data of the compression/expansion circuit 17 is read and written by the CPU 13, and a data transceiving register 22 in which data of the data transceiving FIFO memory 18 is read and written by the CPU 13. It should be noted that the compression/expansion circuit 17 preferably includes circuits, such as, a JPEG circuit used in the compression/expansion of still pictures or an MPEG circuit used in the compression/expansion of moving pictures. Furthermore, when the image processing device 1 is used in an electronic apparatus such as a mobile telephone, the host device 4 includes a processor device that controls main unit functions of that apparatus.

Image expansion data from the electronic camera 2 is stored in the frame memory 16 and displayed on the display panel 3 and is also read in by the CPU 13 via the frame memory register 20 and the high-speed bus 10 and compressed using the compression/expansion circuit 17 and the RAM 15 and the like. The resulting image compression data is written into the transceiving FIFO memory 18 via the peripheral bus 12 and the data transceiving register 22 and sent in order to the host device 4. On the other hand, image compression data from the host device 4 is received at the data transceiving FIFO memory 18 and read in order into the CPU 13 via the data transceiving register 22 and the peripheral bus 12, then expanded using the compression/expansion circuit 17 and the RAM 15 and the like. The resulting image expansion data is stored in the frame memory 16 via the high-speed bus 10 and the frame memory register 20 and displayed on the display panel 3.

Since the high-speed bus 10 operates at a high frequency of 75 MHz, for example, the image expansion data is read in from the frame memory 16 to the CPU 13 at high speed and written from the CPU 13 to the frame memory 16 at high speed. Since the frame memory 16 is connected to the same bus as the RAM 15 used as a working area for computations, overhead time, which is wasted time due to bus switching, can be eliminated in the series of computations. Thus, the CPU operates efficiently in the transfer of image expansion data having large volumes of data and therefore the speed of the overall image processing is increased. Furthermore, data transfers between the CPU 13 and the compression/expansion circuit 17 are via the high-speed bus 10 and therefore the speed of the overall image processing is further increased. On the other hand, the peripheral bus 12 operates at a frequency of 25 MHz, for example, and therefore the writing in of image compression data to the data transceiving FIFO memory 18 and the reading out to the CPU 13 are conducted at a comparatively slow speed. However, the image compression data is, for example, from one-tenth to one one-hundredth of the image expansion data and a comparatively small amount of data, and therefore the speed of the overall image processing is not significantly reduced.

In the image processing device 1, the frame memory 16, which stores a large volume of data, is connected to the high-speed bus 10 having a relatively high processing capability, and the data transceiving FIFO memory 18, which stores a comparatively small volume of data, is connected to the peripheral bus 12 having a relatively low processing capability, and therefore the CPU 13 can be made to operate efficiently and thus achieve greater speed in overall image processing. It should be noted that the data transceiving FIFO memory 18 is connected to the peripheral bus 12 because if there are too many functional circuits connected to the high-speed bus 10, the load capacity of the high-speed bus 10 increases and the operable frequency is reduced by that amount.

In the image processing device 1, the compression/expansion circuit 17 is connected to the high-speed bus 10, but in case the compression/expansion circuit 17 undergoes comparatively little reading and writing by the CPU 13, it may be connected to the peripheral bus 12.

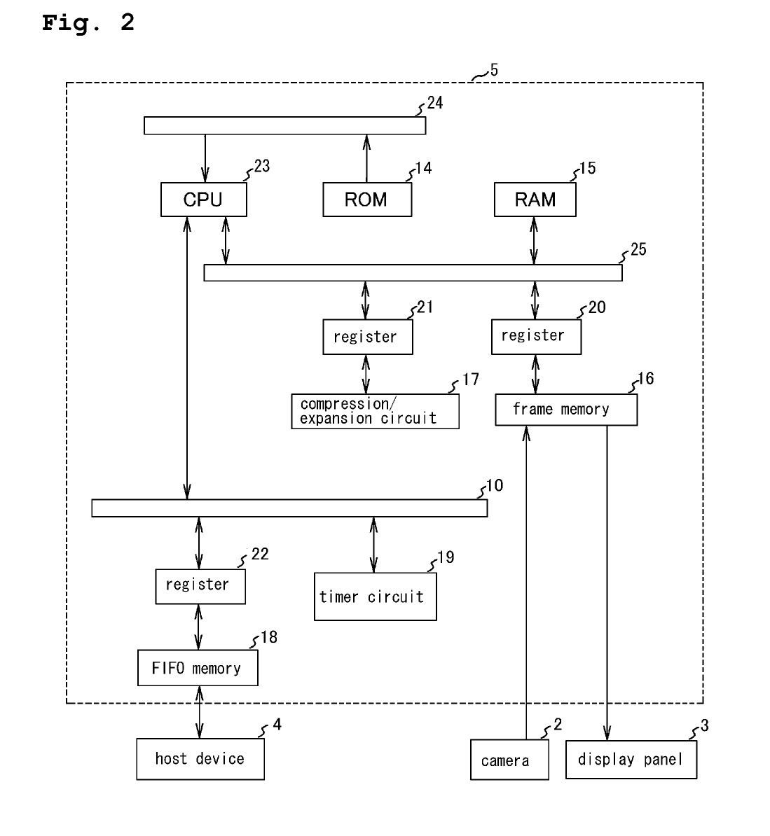

Next, another preferred embodiment of an image processing device according to the present invention is described with reference to FIG. 2. An image processing device 5 has a bus architecture provided with a CPU-direct instruction bus 24 that directly links the CPU 23 and the ROM 14, a CPU-direct data bus 25 that directly links the CPU 23 and the RAM 15, and the a forementioned high-speed bus 10. For example, a TCM (tightly coupled memory) instruction bus in an ARM based processor system, a TCM data bus, and an AMBA (advanced microcontroller bus architecture) bus respectively correspond to the CPU-direct instruction bus 24, the CPU-direct data bus 25, and the high-speed bus 10. It should be noted that the image processing device 5 can also be configured with the peripheral bus 12 (not shown in the drawing) as required.

The CPU-direct data bus 25 is further connected to the aforementioned frame memory 16 and the compression/expansion circuit 17. The high-speed bus 10 is connected to the aforementioned data transceiving FIFO memory 18 and timer circuit 19 and the like. The image processing device 5, as with the image processing device 1, includes the frame memory register 20, the compression/expansion circuit register 21, and the data transceiving register 22.

The CPU-direct instruction bus 24 and the CPU-direct data bus 25 carry out reading and writing operations at, for example, one cycle of the basic operational clock of the CPU 23. On the other hand, the high-speed bus 10 carries out reading and writing operations at, for example, 5 to 10 cycles. Consequently, compared to the image processing device 1, in the image processing device 5, the image expansion data is read in from the frame memory 16 to the CPU 23 at an even greater speed and writes from the CPU 23 to the frame memory 16 at an even greater speed.

In the image processing device 5, the frame memory 16, which stores a large volume of data, is connected to the CPU-direct data bus 25 having a relatively high processing capability, and the data transceiving FIFO memory 18, which stores a comparatively small volume of data, is connected to the high-speed bus 10 having a relatively low processing capability, and therefore, even greater speed can be achieved in overall image processing. It should be noted that the data transceiving FIFO memory 18 is connected to the high-speed bus 10 because the load capacity of the high-speed bus 10 does not increase significantly since the frame memory 16 is shifted to the CPU-direct data bus 25.

In the image processing device 5, the compression/expansion circuit 17 is connected to the CPU-direct data bus 25, but in case the compression/expansion circuit 17 undergoes comparatively little reading and writing by the CPU 23, it may be connected to the high-speed bus 10.

Herein description has been given concerning image processing devices according to preferred embodiments of the present invention, but the present invention is not limited to these preferred embodiments and various design modifications are possible within the scope of the claims. For example, when there is no electronic camera 2 in the electronic apparatus in which the image processing device 1 or 5 is to be used, it is possible to omit a function for storing image expansion data from the electronic camera 2 to the frame memory 16. It is possible whenever required to not include the general-purpose timer circuit 19 and to include other necessary functional circuits.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-4. (canceled)

5. An image processing device comprising:
a high-speed bus and a peripheral bus linked via a bus bridge;
a CPU arranged to carry out computations and control of image processing;
a data transceiving FIFO memory arranged to carry out transceiving of image compression data with a host device;
a frame memory arranged to store image expansion data and to display the data on a display panel; and
a compression/expansion circuit arranged to carry out compression of image expansion data and expansion of image compression data; wherein
the CPU and the frame memory are connected to the high-speed bus, and the data transceiving FIFO memory is connected to the peripheral bus.

6. The image processing device according to claim 5, wherein the compression/expansion circuit is connected to the high-speed bus.

7. An image processing device comprising:
a CPU-direct instruction bus, a CPU-direct data bus, and a high-speed bus;
a CPU arranged to carry out computations and control of image processing;
a ROM arranged to store a processing program of the CPU;
a RAM used as a working area for the computations carried out by the CPU;
a data transceiving FIFO memory arranged to carry out transceiving of image compression data with a host device;
a frame memory arranged to store image expansion data and to display the data on a display panel;
a compression/expansion circuit arranged to carry out compression of image expansion data and expansion of image compression data; wherein
the CPU and the ROM are connected to the CPU-direct instruction bus; the CPU, the RAM, and the frame memory are connected to the CPU-direct data bus; and the CPU and the data transceiving FIFO memory are connected to the high-speed bus.

8. The image processing device according to claim 7 wherein the compression/expansion circuit is connected to the CPU-direct data bus.

9. The image processing device according to claim 7, wherein the CPU-direct instruction bus includes a tightly coupled memory instruction bus.

10. The image processing device according to claim 7, wherein the CPU-direct data bus includes a tightly coupled memory bus.

11. The image processing device according to claim 7, wherein the high-speed includes an advanced microcontroller bus architecture.

12. The image processing device according to claim 7, wherein the high-speed bus operates at a frequency of at least 75 MHz.

13. The image processing device according to claim 5, wherein the high-speed bus operates at a frequency of at least 75 MHz.
